(19) United States
(12) Patent Application Publication
(10) Pub. No.: US 2008/0097022 A1
(43) Pub. Date: Apr. 24, 2008

(54) Extrusion Coating Polyethylene

(76) Inventors: Erkki Laiho, Porvoo (FI); Markku Sainio, Porvoo (FI); Martti Vahala, Nokia (FI)

Correspondence Address: FAY SHARPE LLP, 1100 SUPERIOR AVENUE, SEVENTH FLOOR, CLEVELAND, OH, 44114, US

(21) Appl. No.: 11/793,018

(22) PCT Filed: Jan. 12, 2005
(86) PCT No.: PCT/EP05/00218

§ 371 Date: Sep. 13, 2007

(51) Int. Cl. C08L 23/06

(52) U.S. Cl. 524/487; 524/528; 524/587

(57) ABSTRACT

The present invention relates to a polymer composition with good chemical properties and barrier properties being multimodal and comprising a polymer (A) having a weight average molecular weight of lower than 6000 g/mol and a polyolefin (B) having a higher weight average molecular weight than polymer (A) and a filler (C), whereby a polymer composition without filler (C) has a density of at least 940 kg/m³.

The present invention relates to a polymer composition suitable for extrusion coating and films, preferably cast films having good chemical properties and barrier properties, in particular, a low water-vapor transmission rate (WVTR) and a low curling. Additionally, the present invention relates to the process for producing the inventive composition and its use. Moreover, the present invention is related to a multi-layer material comprising the polymer composition as well as to a process of said multi-layer material.

One of the largest and most rapidly growing polyolefin-processing method is extrusion coating. The largest single volume of coated materials are different papers and paperboards, which are used for a variety of packaging applications. Other material frequently coated are polymer films, cellophane, aluminium foil, freezer wrap paper and fabrics of various kinds. One target for the improvement of coated articles is to reduce the water-vapor transmission rate (WVTR) as much as possible. A coated material with a low water-vapor transmission rate (WVTR) can for example protect the products wrapped therein much better. The demanded requirement applies, of course, not only to coated materials but also to cast films used for packaging or containers. In both cases, a low water-vapor transmission rate is required. Much effort has been undertaken to improve the water-vapor transmission rate of coated materials as well as for cast films. To date, several new polymer compositions have been developed and much effort has been undertaken to find appropriate fillers to improve the barrier properties significantly. Furthermore, different polymers have been designed as cyclo-olefin copolymers (COC) and liquid crystal polymers (LCP). However, these materials have the drawback of being expansive and having minor processability properties.

WO 00/71615 discloses for example the use of a bimodal high density polyethylene (HDPE) with a melt flow rate, MFR₂, of 5 g/10 min and a density of 957 kg/m³ for extrusion coating. No information is given how to improve the water-vapor transmission rate (WVTR).

WO 00/34580 describes release liner for pressure-sensitive adhesive labels. The release-liner contains a paper wrap, a filled polymer layer, and, on the opposite of the paper web, an extrudate, e.g. polyethylene, and on the top of the extrudate, a release film. The filled polymer layer can be polyethylene and the filler is an inert particulate, such as silica, mica, clay, talc and titanium oxide. The filler is present in 15 to 40 wt % of the composition.

U.S. Pat. No. 4,978,572 describes a laminated film having three layers. The first layer comprises a thermoplastic resin and 0.3 to 30 wt % white inorganic particles. The second one comprises an ethylene copolymer, 0.5 to 90 wt % of a substance giving anti-block action and anti-oxidant. The third one comprises a metallized thermoplastic. The substance giving anti-block action of the second layer may be silica or talc. The laminated film is reported to have good mechanical strength and good barrier properties.

Even though the prior art offers already a variety of products having good water-vapor transmission rates (WVTR), there is still demand for a significant improvement of these properties. One significant disadvantage in polymer compositions comprising fillers reducing the water-vapor transmission rate (WVTR) is the low dispersion of the fillers incorporated in the polymer matrix. Conventional mechanical incorporation frequently results in poor dispersion as usual fillers form multi-layer aggregation caused by incompatibility with polymer matrix. One consequence of the described phenomenon is that the water-vapor transmission rate (WVTR) varies considerably in the layer leading to unsatisfying average values for the WVTR. Secondly, the low dispersion of the filler causes an easy upcurling of the polymer composition coated on the materials. Hence, a uniform dispersion of fillers incorporated in a polymer composition should improve the water-vapor transmission rate significantly, and, additionally, the curling properties of a coated material should be enhanced.

Hence, the object of the present invention is to improve the water-vapor transmission rate (WVTR).

The present invention is based on the finding that the object can be addressed by a polymer composition comprising a polymer having a low average molecular weight enabling an enhanced and uniform dispersion of fillers incorporated in the polymer composition.

The present invention therefore provides a multimodal polymer composition comprising
a. at least one polymer (A) having a weight average molecular weight (M_{w}) of lower than 60,000 g/mol;
b. at least one polyolefin (B) having a higher weight average molecular weight-(M_{w}) than polymer (A); and
c. a filler (C) whereby the polymer composition without filler (C) has a density of at least 940 kg/m³.

It is preferred that the polymer composition consists of
a. at least one polymer (A) having a weight average molecular weight (M_{w}) of lower than 60,000 g/mol;
b. at least one polyolefin (B) having a higher weight average molecular weight (M_{w}) than polymer (A); and
c. a filler (C) whereby the polymer composition without filler (C) has a density of at least 940 kg/m³.

Accordingly the polymer composition according to this invention is multimodal with respect to the molecular weight distribution. “Multi-modal” or “multimodal distribution” describes a frequency distribution that has several relative maxima. In particular, the expression “modality of a polymer” refers to the form of its molecular weight distribution (MWD) curve, i.e. the appearance of the graph of the polymer weight fraction as a function of its molecular weight. The molecular weight distribution (MWD) of a polymer produced in a single polymerization stage using a single monomer mixture, a single polymerization catalyst and a single set of process conditions (i.e. temperature, pressure, etc.) shows a single maximum the breadth of which depends on catalyst choice, reactor choice, process conditions, etc., i.e. such a polymer is monomodal.

This inventive composition is characterized by a very low water-vapor transmission rate (WVTR) and also by low curling-values for extrusion-coated layers. These improved properties are reached by a much better dispersion of the filler (C) in the polymer mixture of polymer (A) and polyolefin (B) compared with an unimodal polymer having the same melt index and density for both extrusion-coated layers and cast films.

Hence, the polymer composition according to this invention is a multimodal including bimodal polymer composition consisting of at least two different polymers having two different molecular weight distribution curves and are blended mechanically or in situ during the preparation thereof. Preferably the polymer composition is at least a bimodal mechanical or in-situ blend of a polyolefin (1) (as polymer (A)) and polymer (B). In case such a bimodal blend comprises further a wax (2) as an additional polymer (A), then the final polymer composition may also be trimodal.

The molecular weight distribution (MWD) is the relation between the numbers or molecules in a polymer and their individual chain length. The molecular weight distribution (MWD) is often given as a number, which normally means weight average molecular weight (M_{w}) divided by number average molecular weight (Mₙ).

The weight average molecular weight (M_{w}) is the first moment of a plot of the weight of polymers in each molecular weight range against molecular weight. In turn, the number average molecular weight (Mₙ) is an average molecular weight of a polymer expressed as the first moment of a plot of the number of molecules in each molecular weight range against the molecular weight. In effect, this is the total molecular weight of all molecules divided by the number of molecules.

The number average molecular weight (Mₙ) and the weight average molecular weight (M_{w}) as well as the molecular weight distribution (MWD) are determined according to ISO 16014.

The weight average molecular weight (M_{w}) is a parameter for the length of the molecules in average. Low M_{w}-values indicate that the chain length of the molecules are rather short in average. It has been found out that a polymer mixture comprising a polymer (A) with M_{w}-values of lower than 60,000 g/mol contributes inter alia to better barrier properties and better dispersion of the filler (C). Such better dispersion improves the water-vapor transmission rate (WVTR) as well as the curling resistance positively.

Hence, as a further requirement of the present invention, the multimodal polymer composition must comprise at least one polymer (A) having a weight average molecular weight (M_{w}) of lower than 60,000 g/mol. It is in particular preferred that at least one polymer (A) having a weight average molecular weight (M_{w}) of lower than 60,000 g/mol is at least one polyolefin (1) having a weight average molecular weight (M_{w}) of 10,000 to 60,000 g/mol, more preferably of 20,000 to 50,000 g/mol and/or at least one wax (2) having a weight average molecular weight (M_{w}) of less than 10,000 g/mol, more preferably in the range of 500 to 10,000 g/mol.

Moreover, it is preferred that the polyolefin (1) is a polyethylene or polypropylene, more preferably a polyethylene. The polyolefin (1) can be a homopolymer or copolymer. It is preferred that the polyolefin (1) is a homopolymer or copolymer of propylene or ethylene, more preferred the polyolefin (1) is a homopolymer or copolymer of ethylene. Most preferably the polyolefin (1) is a high density polyethylene (HDPE) produced in a high pressure process or low pressure process, preferably in a low pressure process. In a low pressure process a polymerization catalyst known in the art, e.g. a Ziegler-Natta catalyst, a metallocene or non-metallocene catalyst, or any mixture thereof, is employed.

In case polymer (A) is a wax (2), it is preferred that it is selected from one or more of
(2a) a polypropylene wax having a weight average molecular weight (M_{w}) of less than 10,000 g/mol, more preferably in the range of 500 to 10,000 g/mol, still more preferably in the range of 1000 to 9000 g/mol, yet more preferably in the range of 2000 to 8000 g/mol and most preferably in the range of 4000 to 8000 g/mol or a polyethylene wax having a weight average molecular weight (M_{w}) of less than 10,000 g/mol, more preferably in the range of 500 to 10,000 g/mol, still more preferably in the range of 1000 to 9000 g/mol, yet more preferably in the range of 2000 to 8000 g/mol and most preferably in the range of 4000 to 8000 g/mol, and
(2b) an alkyl ketene dimer wax having weight average molecular weight (M_{w}) of less than 10,000 g/mol, more preferably lower than 5000 g/mol, yet more preferably lower than 1000 g/mol. In turn the alkyl ketene dimer wax has preferably weight average molecular weight (M_{w}) of at least 100 g/mol. Most preferred the alkyl ketene dimer wax has weight average molecular weight (M_{w}) in the range of 250 to 1000 g/mol.

The terms “at least one polymer (A)”, “at least one polyolefin (1)” or “at least one wax (2)” shall indicate that more than one polymer (A), polyolefin (1) or wax (2) can be present in the multimodal polymer composition. It is preferred that three, two or one different polymers (A) as defined above are used in a multimodal polymer composition. Still more preferred is that wax (2), preferably a polypropylene wax (2a) or an alkyl ketene dimer wax (2b) as defined above is used as a component (A) only. In case the component (A) comprises a polyolefin (1) as defined above, it is preferred that a wax (2) is present in the multimodal polymer composition as a further polymer (A). In such cases the multimodal composition is preferably trimodal comprising polyolefin (1), wax (2) and polyolefin (B) having different centered maxima in their molecular weight distribution, e.g. having different weight average molecular weights (M_{w}). The use of the wax (2) has the benefit that the amorphous region of the polymer matrix, which may be a mix of polyolefin (1) and polyolefin (B), is filled up and improves thereby the barrier properties.

It is preferred that not only the final polymer composition has a specific density of at least 940 kg/m³ but also the polymer (A) may have a specific density.

Preferably in case for polyolefin (1) a homopolymer is used the density may be of at least 940 kg/m³, more preferably of at least 970 kg/m³. The upper limit for the polyolefin (1) being a homopolymer may be 978 kg/m³. A Preferred range for the polyolefin (1) being a homopolymer is of 950 to 978 kg/m³, more preferably of 970 to 978 kg/m³.

In case for the polyolefin (1) a copolymer is used, it is preferred that the polyolefin (1) has a density of at least 930 kg/m³. A preferred upper limit for the polyolefin (1) being a copolymer may be 970 kg/m³. In one embodiment the particular the polyolefin (1) being a copolymer has a density of 940 to 968 kg/m³, more preferably of 940 to 965 kg/m³, and most preferably of 945 to 965 kg/m³. Alternatively the density of the polyolefin (1) being a copolymer is of 950 to 968 kg/m³, more preferably of 950 to 965 kg/m³, and most preferably of 955 to 965 kg/m³. It is in particular preferred that the polyolefin (1) being a copolymer is a high density polyethylene (HDPE) preferably having a density as given in this paragraph.

Having a polymer (A) with such high densities has the benefit that the dispersion of filler (C) in the polymer mix of polymer (A) and polyolefin (B) can be enhanced compared with a mix having a lower density of polymer (A).

The molecular weight distribution (MWD) of the polymer composition is further characterized by the way of its melt flow rate (MFR) according to ISO 1133 at 190° C. The melt flow rate (MFR) mainly depends on the average molecular weight. The reason for this is that long molecules give the material a lower flow tendency than short molecules.

An increase in molecular weight means a decrease in the MFR-value. The melt flow rate (MFR) is measured in g/10 min of the polymer discharged under specific temperature and pressure conditions and is the measure of a viscosity of the polymer which in turn for each type of polymer is mainly influenced by its molecular weight distribution, but also by its degree of branching. The melt flow rate measured under a load of 2.16 kg (ISO 1133) is denoted as MFR₂. In turn, the melt flow rate measured with 5 kg load (ISO 1133) is denoted as MFR₅.

In case polymer (A) is a polyolefin (1) being a homopolymer, it is preferred that MFR₂ is in the range of 50.0 to 2000.0 g/10 min, more preferably in the range of 100.0 to 1000.0 g/10 min, still more preferably in the range of 200.0 to 1000.0 g/10 min and most preferably in the range of 200.0 to 600.0 g/10 min. It is in particular preferred that the polymer (1) being a homopolymer has a MFR₂ as defined in this paragraph and a density as defined above simultaneously. Moreover it is preferred that the polyolefin (1) being an ethylene homopolymer contains less than 0.2 mol %, more preferably less than 0.1 mol % and most preferably less than 0.05 mol % units derived from alpha-olefins other than ethylene.

In case the polymer (A) is polyolefin (1) being an ethylene copolymer, the ethylene copolymer preferably comprises, more preferably consists of, comonomer units as defined below for the HDPE. Moreover it is preferred that the polyolefin (1) being a copolymer, has a MFR₂ in the range of 1.0 to 25.0 g/10 min, more preferably in the range of 5.0 to 20.0 g/10 min and most preferably in the range of 7.0 to 15.0 g/10 min. It is in particular preferred that the polyolefin (1) being a copolymer is a high density polyethylene (HDPE) preferably with MFR₂ as given in this paragraph. In addition it is preferred that the polymer (1) being a copolymer has a MFR₂ as defined in this paragraph and a density as defined above simultaneously.

In case polymer (A) is a wax (2a), namely a polypropylene wax or a polyethylene wax, it is preferred that the wax (2a) has a weight average molecular weight (M_{w}) in the range of 500 to 10,000 g/mol, more preferably in the range of 1,000 to 9,000 g/mol, still more preferably in the range of 2,000 to 8,000 g/mol and most preferably in the range of 4,000 to 8,000 g/mol. Further preferred ranges for the weight average molecular weight (M_{w}) of the wax (2a), in particular the polypropylene or polyethylene wax, is in the range of 4,000 to 7,000 g/mol, still more preferably in the range of 5,000 to 6,000 g/mol and most preferably in the range of 5,300 to 5,400 g/mol. Additionally, it is preferred that the wax (2a), in particular the polypropylene wax or polyethylene wax, has a z-average molecular weight of 9,100 to 40,000 g/mol, more preferably from 500 to 20,000 g/mol and most preferably from 10,000 to 12,000 g/mol. It is additionally preferred that the wax (2a), in particular the polypropylene wax or the polyethylene wax, has a number average molecular weight (Mₙ) of 100 to 20,000 g/mol, more preferably of 500 to 3,000 g/mol.

Moreover, it is preferred that wax (2a), in particular polypropylene wax or polyethylene wax, has a specific molecular weight distribution (MWD) which is the relation between the number of molecules in the polymer and their individual chain length. The molecular weight distribution is given as a number which means weight average molecular weight divided by number average molecular weight (M_{w}/Mₙ). It is preferred that the wax (2a), in particular the polypropylene wax or the polyethylene wax, has an MWD in the range of 1 to 5, more preferably in the range of 1.5 to 4.

In addition, it is preferred that the wax (2a), in particular the polypropylene wax or the polyethylene wax, has a melting temperature in DSC-analysis of below 150° C., more preferably below 140° C., still more preferably in the range of 95 to 130° C., most preferably in a range of 105 to 115° C.

In case a wax (2b), namely an alkyl-ketene dimer, is employed as polymer (A), it is preferred that the weight average molecular weight (M_{w}) of the wax (2b) is higher than 100 g/mol. In turn, it is preferred that the weight average molecular weight of the wax (2b) is lower than 10,000 g/mol, more preferably lower than 5,000 g/mol, still more preferably lower than 1,000 g/mol. Preferred ranges for the weight average molecular weight (M_{w}) of the wax (2b) is 100 to 10,000 g/mol, more preferably 250 to 1,000 g/mol. Additionally, it is preferred that the wax (2b) has a number average molecular weight (Mₙ) of 100 to 20,000 g/mol, more preferably in the range of 100 to 800 g/mol. In addition, it is preferred that wax (2b) has a melting temperature in DSC-analysis below 140° C., more preferably below 100° C. A preferred range for the melting temperature in DSC-analysis is 50 to 90° C., more preferably 50 to 70° C.

As a further requirement, according to the present invention, the polyolefin (B) shall have a higher weight average molecular weight (M_{w}) than polymer (A). It is preferred that the polyolefin (B) has a weight average molecular weight (M_{w}) of higher than 80,000 g/mol, more preferably higher than 100,000 g/mol. The upper limit for the weight average molecular weight (M_{w}) for polyolefin (B) shall preferably not be higher than 300,000 g/mol, more preferably not higher than 200,000 g/mol. The preferred range for the weight average molecular weight (M_{w}) for polyolefin (B) is 80,000 to 300,000 g/mol, more preferably from 100,000 to 200,000 g/mol. Preferably, polyolefin (B) is a high density polyethylene (HDPE) with the weight average molecular weight (M_{w}) as given in this paragraph.

According to this invention, more than one polyolefin (B) can be used.

It is preferred that the polyolefin (B) is a polyethylene. In case the polyolefin (B) is a polyethylene, it may be an ethylene homopolymer or an ethylene copolymer.

In case for the polyolefin (B) an ethylene homopolymer is employed, then preferably an ethylene homopolymer is used as defined for polyolefin (1). Accordingly it is preferred that the density of polyolefin (B) being a homopolymer is of at least 940 kg/m³, more preferably of at least 970 kg/m³. The upper limit for the polyolefin (B) being a homopolymer may be 978 kg/m³. A Preferred range for the polyolefin (B) being a homopolymer is of 950 to 978 kg/m³, more preferably of 970 to 978 kg/m³. Moreover it is preferred that the polyolefin (B) being a homopolymer has a MFR₂ in the range of 50.0 to 2000.0 g/10 min, more preferably in the range of 100.0 to 1000.0 g/10 min, still more preferably in the range of 200.0 to 1000.0 g/10 min and most preferably in the range of 200.0 to 600.0 g/10 min. It is in particular preferred that the polymer (B) being a homopolymer has a MFR₂ and a density as defined in this paragraph simultaneously. Moreover it is preferred that the polymer (B) being an ethylene homopolymer contains less than 0.2 mol %, more preferably less than 0.1 mol % and most preferably less than 0.05 mol % units derived from alpha-olefins other than ethylene.

In case for the polyolefin (B) an ethylene copolymer is employed, then preferably an ethylene copolymer is used as defined for polyolefin (1). Accordingly it is preferred that the polyolefin (B) being an ethylene copolymer has a density of at least 930 kg/m³. A preferred upper limit for the polyolefin (B) being a copolymer may be 970 kg/m³. In one embodiment the particular the polyolefin (B) being a copolymer has a density of 940 to 968 kg/m³, more preferably of 940 to 965 kg/m³, and most preferably of 945 to 965 kg/m³. Alternatively the density of the polyolefin (B) being a copolymer is of 950 to 968 kg/m³, more preferably of 950 to 965 kg/m³, and most preferably of 955 to 965 kg/m³. It is in particular preferred that the polyolefin (B) being a copolymer is a high density polyethylene (HDPE) preferably having a density as given in this paragraph. Moreover it is preferred that the polyolefin (B) being an ethylene copolymer, is an ethylene copolymer preferably comprising, more preferably consisting of, comonomer units as defined below for the HDPE. In addition it is preferred that the polyolefin (B) being a copolymer, has a MFR₂ in the range of 1.0 to 25.0 g/10 min, more preferably in the range of 5.0 to 20.0 g/10 min and most preferably in the range of 7.0 to 15.0 g/10 min. It is in particular preferred that the polyolefin (B) being a copolymer is a high density polyethylene (HDPE) preferably with MFR₂ as given in this paragraph. In addition it is preferred that the polymer (B) being a copolymer has a MFR₂ and a density as defined in this paragraph simultaneously.

It is in particular preferred that the polymer composition according to this invention is a high density polyethylene (HDPE) comprising polyolefin (1) (polymer (A)) as a low molecular weight fraction of HDPE and polyolefin (B) as a high molecular weight fraction of HDPE. This high density polyethylene (HDPE) may be a mechanical blend, preferably an in-situ blend, produced in a multistage process. Preferably said composition comprises wax (2) as a further polymer (A).

According to a preferable embodiment the polymer composition as defined above comprises 1 to 50 wt % of polymer (A), 40 to 90 wt % of polyolefin (B) and 1 to 50 wt %, more preferably 5 to 40 wt %, and most preferably 10 to 35 wt % of filler (C). In case the polymer composition is produced in an in situ polymerization process, e.g. a sequential step process by utilizing reactors coupled in series and described as above, it is preferred that the polymer (A) may range from 40 to 60 wt %, more preferably 49 to 55 wt % in the polymer mix without filler (C). In turn, it is preferred that in such a polymer mix, the polyolefin (B) ranges from 60 to 40 wt %, more preferably from 51 to 45 wt %. Preferably, the total polymer composition comprises 50 to 99 wt % of said polymer mix and of 1 to 50 wt % more preferably 5 to 40 wt %, and most preferably 10 to 35 wt % filler (C).

In case polymer (A) and polyolefin (B) are blended mechanically, it is preferred that polymer (A) ranges from 1 to 30 wt % and, more preferably, from 1 to 20 wt % in the total polymer composition. These ranges apply in particular in case for polymer (A) a wax (2) is used only.

The last requirement according to the present invention is that the multimodal polymer composition additionally comprises a filler (C). Any filler having a positive influence on the water-vapor transmission rate (WVTR) can be used. Preferably, the filler shall be lamellar, such as clay, mica or talc. More preferably, the filler shall be finely divided. The finely divided filler consists of about 95 wt % of particles having particle sizes of less than 10 μm, and about 20-30 wt % of particles having a particle size of less than 1 μm. In the present invention all layer materials may be used as long as they have the ability to disperse in the polymer composition. The filler may either be a clay-based compound or a submicron filler such as talc, calcium carbonate or mica, which usually have been treated, for instance by grinding, to obtain particles of small, i.e. submicron, dimensions, in situ as stated above.

It is preferred that the filler (C) is layered silicate material, still more preferred, filler (C) is a clay-based compound. Clay-based compounds upon compounding of the polymer composition are dispersed in the polymer composition so that individual platelets in the layered structure are separated.

In a further preferred embodiment, the filler (C) is a clay-based layered inorganic, preferably silicate material or material mixture. Such useful clay materials include natural, synthetic and modified phyllosilicates. Natural clays include smectite clays, such as montmorillonite, hectorite, mica, vermiculate, bentonite. Synthetic clays include synthetic mica, synthetic saponite, synthetic hectorite. Modified clays include fluorinated montmorillonite, fluorinated mica.

Of course, the filler (C) may also contain components comprising a mixture of different fillers, such as mixtures of a clay-based filler and talc.

Layered silicates may be made organophylic before being dispersed in the polymer composition by chemical modification, such as by cation-exchange treatment using alkyl ammonium or phosphonium cation complexes. Such cation complexes intercalate between the clay layers.

Preferably, a smectite type clay is used, which comprises montmorinollite, beidellite, nontronite, saponite, as well as hectonite. The most preferred semicite type clay is montmorinollite.

Preferably, also talc is used as a filler (C).

The density affects most physical properties like stiffness impact strength and optical properties of the end products. Hence, and according to the present invention, the density of the polymer composition shall be of at least 940 kg/m³. More preferably, the density shall range from 950 to 968 kg/m³, still more preferably 950 to 965 kg/m³ and most preferably 955 to 965 kg/m³

The ranges and values given for the density in the whole invention apply for pure polymer compositions and do not include any additives, in particular no filler (C). The density is determined according to ISO 1183-1987.

Moreover, it is preferred that the polymer composition without any additive, preferably without filler (C) has a melt flow rate MFR₂ according to ISO 1133 at 190° C. of 5 to 20 g/10 min, more preferably from 7 to 15 g/10 min.

Preferably, the polymer composition without any additive, preferably without filler (C) has a melt flow rate MFR₅ according to ISO 1133 at 190° C. of 20 to 40 g/10 min, more preferably of 25 to 35 g/10 min.

Moreover, it is preferred that the melt flow ratio, which is a ratio of two melt flow rates measured for the same polymer under two different loads, falls within a specific range. The preferred specific range is 2.5 to 4.5, more preferably 2.7 to 4.0, for the melt flow ratio MFR₅/MFR₂.

A further characteristic of the molecular weight distribution (MWD) which is the relation between the number of molecules in a polymer and their individual chain length has to be considered. The width of the distribution is a number as a result of the ratio of the weight average molecular weight divided by the number average molecular weight (M_{w}/Mₙ). In the present invention, it is preferred that the polymer composition without any additive, preferably without filler (C), has a M_{w}/Mₙ of preferably 8 to 25 and more preferably from 10 to 20.

Additional additives, e.g. inorganic additives, known as exipients and extrusion aids in the field of coatings and films, are used.

For a better adhesion between the coating and the substrate, it is preferred that the polymer is oxidized. Consequently, it is preferred that the polymer composition contains anti-oxidants and process stabilizers less than 2,000 ppm, more preferably less than 1,000 ppm and most preferably not more than 700 ppm. The anti-oxidants thereby may be selected from those known in the art like those containing hindered phenols, secondary aromatic amines, thio-ethers or other sulfur-containing compounds, phosphites and the like including their mixtures.

It has been found that the polymer composition as described above has a very low water-vapor transmission rate (WVTR). Additionally, the composition has a good adhesion to the substrate, in particular to aluminium, without any need to have an adhesion layer between the substrate and the coating. Further, the tendency of the coated article to curl is significantly reduced for the polymer composition compared to neat polymer. These advantageous effects could only be achieved as the miscibility between the polymer and the filler is much higher for a multimodal or bimodal polymer having a low molecular weight polymer fraction in comparison with a unimodal polymer having the same melt index and density.

In one preferable embodiment, the multimodal composition comprises as polymer (A), which is the low molecular weight fraction, a polyolefin (1), more preferably a high density polyethylene (HDPE). The polyolefin (B), which is the high molecular weight fraction, is a high density polyethylene (HDPE). It is preferred that the polymer (A) and the polyolefin (B) are of the same polymer type, e.g. are a HDPE. Preferably, this composition comprises a further polymer (A) which is a wax (2) as defined above. This composition can be produced in an in situ process or can be blended mechanically. Preferred properties for the polymer (A), in particular the polyolefin (1), the wax (2) and the polyolefin (B) are those as given above. In case this composition comprises two polymers (A), namely a polyolefin (1) and a wax (2), it is preferred that the amount of wax (2) in the total composition without filler (C) is 1 to 30 wt %, more preferably 1 to 20 wt % and most preferably 1 to 10 wt %. In turn, the composition comprises 70 to 99 wt %, more preferably 80 to 99 wt % and most preferably 90 to 99 wt % of HDPE resulting from polymer (A) and polyolefin (B). In case the composition comprises HDPE as a polymer (A), it is preferred that wax (2) is present in the amount of 1 to 30 wt % and HDPE resulting from polymer (A) and polyolefin (B) is present in the amount of 70 to 99 wt % in the total composition without filler (C).

In case polymer (A) and polyolefin (B) of the composition comprise HDPE then the polymer composition is produced in an in situ process, whereby the sequential step process by utilizing reactors coupled in series as described below is preferred. Preferably polymer (A) is produced in a loop reactor whereas polyolefin (B) is produced in a gas phase reactor in the presence of polymer (A). Thereby, it is preferred that the multimodal polymer is at least a bimodal polymer. The polymer composition of this embodiment comprises 50 to 99 wt % of a high density polyethylene (HDPE) having a multimodal, more preferably a bimodal molecular weight distribution (MWD) and more preferably 1 to 50 wt %, still more preferably 5 to 40 wt %, and most preferably 10 to 35 wt % of a filler (C). Preferably the filler (C) is a plate- or sheet-like filler such as mica or talc as described above.

In the following, when the description refers for this embodiment to HDPE, it means that a multimodal, preferably bimodal HDPE, which comprises a low molecular weight (LMW) fraction, which is polymer (A) (polyolefin (1)), and a high molecular weight (HMW) fraction, which is polymer (B), is used.

Preferably, the high density polyethylene (HDPE) has a melt index MFR₂ from 1 to 25 g/10 min, more preferably of 5.0 to 20 g/10 min, still more preferably from 7 to 15 g/10 min. It is preferred that the high density polyethylene (HDPE) ranges from 950 to 968 kg/m³, more preferably from 950 to 965 kg/m³, most preferably from 955 to 965 kg/m³. If the melt index of the high density polyethylene (HDPE) is lower than 1 g/10 min, a high throughput is not reached. On the other hand, if the melt index MFR₂ is higher than 25, the melt strength of the polyethylene suffers.

In addition, it is preferred that the high density polyethylene (HDPE) has a melt flow index MFR₅ from 20 to 40 and preferably a melt flow ratio MFR₅/MFR₂ from 2.5 to 4.5, more preferably from 2.7 to 4.0. Furthermore, it is preferred that the high density polyethylene (HDPE) has a weight average molecular weight (M_{w}) from 50,000 to 150,000 g/mol, more preferably from 60,000 to 100,000 g/mol and preferably a ratio of the weight average molecular weight to the number average molecular weight M_{w}/Mₙ of 8 to 25, more preferably of 10 to 20.

Moreover, the high density polyethylene (HDPE) contains comonomers selected from the group consisting of C₃ alpha-olefin, C₄ alpha-olefin, C₅ alpha-olefin, C₆ alpha-olefin, C₇ alpha-olefin, C₈ alpha-olefin, C₉ alpha-olefin, C₁₀ alpha-olefin, C₁₁ alpha-olefin, C₁₂ alpha-olefin, C₁₃ alpha-olefin, C₁₄ alpha-olefin, C₁₅ alpha-olefin, C₁₆ alpha-olefin, C₁₇ alpha-olefin, C₁₈ alpha-olefin, Cl₁₉ alpha-olefin, C₂₀ alpha-olefin. Especially preferred are alpha-olefins selected from the group consisting of propylene, 1-butene, 1-pentene, 4-methyl-1-pentene, 1-hexene, 1-heptene, 1-octene, 1-nonene, 1-decene, 6-methyl-1-heptene, 4-ethyl-1-hexene, 6-ethyl-1-octene and 7-methyl-1-octene. Still more preferred, alpha-olefins are selected from the group consisting of 1-butene, 4-methyl-1-pentene, 1-hexene and 1-octene.

As one requirement of the preferred embodiment is that the polymer composition is a high density polyethylene (HDPE) the content of the comonomer units in the polymer is preferably 0.1 to 1.0 mol %, more preferably 0.15 to 0.5 mol %.

It is preferred that the high density polyethylene (HDPE) without filler (C) comprises 40 to 60 wt %, more preferably 49 to 55 wt % polymer (A) and 60 to 40 wt %, and more preferably 51 to 45 wt % polyolefin (B).

As stated above, it is preferred that the high density polyethylene (HDPE) comprises a polyolefin as a polymer (A). More preferably, the polymer (A) is a polyolefin (1), most preferably an ethylene copolymer containing alpha-olefins other than ethylene and listed above. Furthermore, it is preferred that the polymer (A) of the high density polyethylene (HDPE) has a weight average molecular weight (M_{w}) of 10,000 to 60,000 g/mol, more preferably from 20,000 to 50,000 g/mol. It is further preferred that polymer (A) of the high density polyethylene (HDPE), has a density of at least 971 kg/m³, more preferably of at least 973 kg/m³. In addition, it is preferred that polymer (A) of the high density polyethylene (HDPE) has a melt flow rate MFR₂ from 100.0 to 2000.0 g/10 min, more preferably from 250.0 to 1000.0 g/10 min.

It is preferred that polyolefin (B) as the high density polyethylene (HDPE) is an ethylene copolymer containing one or more alpha-olefins as listed above. The polyolefin (B) may be a high density polyethylene (HDPE). Thereby, it is preferred that the amount of comonomer units in polyolefin (B) is from 0.2 to 2.0 mol %, more preferably from 0.3 to 1.0 mol %. In addition, it is preferred that the polyolefin (B) in the high density polyethylene (HDPE) has a weight average molecular weight from 80,000 to 300,000 g/mol, more preferably from 100,000 to 200,000 g/mol.

The filler (C) and other additional components in the high density polyethylene (HDPE), are identically used as listed and described above. It is in particular preferred that additionally to the HDPE, a wax (2), more preferably a polypropylene wax (2a) or an alkyl-ketene dimer (2b) as defined above is used as an additional polymer (A).

In case two polymers (A) are used, namely polyolefin (1) and wax (2), the amount of wax (2) is 1 to 30 wt %, more preferably 2 to 20 wt % and most preferably 1 to 10 wt % in the total composition without filler (C). In turn, the composition without filler (C) comprises 70 to 99 wt %, more preferably 80 to 88 wt % and most preferably 90 to 99 wt % HDPE resulting from polymer (A) and polyolefin (B).

Another preferred embodiment of the present invention is a polymer composition whereby polymer (A) and polyolefin (B) are preferably mechanically blended. Thereby it is preferred that polymer (A) is a wax (2), more preferably a polypropylene wax (2a) or an alkyl-ketene dimer wax (2b).

In case of polymer (A), where a polypropylene wax (2a) is used, it is preferred that this wax (2a) has a weight average molecular weight (M_{w}) of 100 to 50,000, more preferably from 100 to 10,000, and most preferably from 5,000 to 6,000. In addition, it is preferred that the z-average molecular weight of the polypropylene wax (2a) ranges from 100 to 60,000 g/mol, and more preferably from 100 to 10,000 g/mol. It is preferred that the polypropylene wax (2a) has a number average molecular weight (Mₙ) of 100 to 2,000 g/mol, more preferably 500 to 3,000 g/mol. The melting temperature in DSC-analysis of the polypropylene wax (2a) is preferably of 95 to 130° C., more preferably 105 to 115° C.

Preferably, the polypropylene wax (2a) is mechanically blended with an ethylene polymer as a polyolefin (B) having an MFR₂ of 3.0 to 20.0 g/10 min, more preferably from 5.0 to 15.0 g/10 min and a density of 940 to 970 kg/m³, more preferably from 945 to 965 kg/m³. In some cases the density may be of 955 to 970 kg/m³, more preferably of 960 to 965 kg/m³. It is in particular preferred that polyolefin (B) is a high density polyethylene (HDPE) as described above.

The mechanically blended polymer including a talc as filler (C) has preferably a density ranging from 1,000 kg/m³ to 1,300 kg/m³, more preferably of 1,150 to 1,200 kg/m³ and a melt flow rate MFR₂ of preferably 8 to 9.5 g/10 min, and more preferably of 8.5 to 9.0 g/10 min.

The other preferred alternative of a mechanical blend of wax (2) with polyolefin (B) is to use an alkyl-ketene dimer (2b) as wax (2). Preferably, this alkyl-ketene dimer (2b) has a weight average molecular weight (M_{w}) of 300 to 400 g/mol, more preferably from 320 to 350 g/mol. Preferably, the z-average molecular weight of the alkyl-ketene dimer (2b) is from 300 to 400 g/mol, more preferably from 360 to 390 g/mol. It is preferred that the alkyl-ketene dimer (2b) has a number average molecular weight (M_{w}) of 200 to 450 g/mol, more preferably from 280 to 300 g/mol. In addition, it is preferred that the alkyl-ketene dimer (2b) has a melting temperature DSC-analysis of 55 to 70° C., more preferably from 60 to 65° C.

For polyolefin (B), the same ethylene polymer is used as defined under the mechanical blend comprising a polypropylene wax (2a).

The density of the mechanically blended polymer composition comprising an alkyl-ketene dimer (2b) as defined above, an ethylene polymer (B) as defined above, a filler (C) and a water-absorbent component has preferably a density of 1,050 to 1,300 kg/m³ and more preferably from 1,150 to 1,250 kg/m³. The melt flow rate MFR₂ of this polymer composition is preferably from 12.5 g/10 min to 14.5 g/10 min and more preferably from 13 to 14 g/10 min. It is preferred that for this embodiment for filler (C) talc is employed.

As an alternative solution the present invention provides a multimodal polymer composition comprising
a. a polymer (A) being a polyethylene homopolymer having a weight average molecular weight (M_{w}) of lower than 60000 g/mol, more preferably of 10000 to 60000 g/mol, and a MFR₂ of 50 to 1000 g/10 min, preferably of 100 to 600 g/10 min;
b. a polyolefin (B) being a polyethylene copolymer having a higher weight average molecular weight (M_{w}) than the polymer (A), a density of 940 to 970 kg/m³, preferably of 945 to 968 kg/m³, and a MFR₂ of 1 to 25 g/10 min, preferably of 5 to 20 g/10 min; and
c. 1 to 50 wt % of a filler (C), whereby the polymer composition without filler (C) has a density of at least 940 kg/m³.

Moreover as an alternative it is preferred that the polymer composition consists of
a. a polymer (A) being a polyethylene homopolymer having a weight average molecular weight (M_{w}) of lower than 60000 g/mol, more preferably of 10000 to 60000 g/mol, and a MFR₂ of 50 to 1000 g/10 min, preferably of 100 to 600 g/10 min;
b. a polyolefin (B) being a polyethylene copolymer having a higher weight average molecular weight (M_{w}) than the polymer (A), a density of 940 to 970 kg/m³, preferably of 945 to 968 kg/m³, and a MFR₂ of 1 to 25 g/10 min, preferably of 5 to 20 g/10 min; and
c. 1 to 50 wt % of a filler (C), whereby the polymer composition without filler (C) has a density of at least 940 kg/m³.

For this embodiment it is preferred that 1 to 30 wt %, more preferably 1 to 20 wt %, and most preferably 1 to 10 wt % of wax (2) is used as a further polymer (A). It is in particular preferred that the wax (2) is a polypropylene wax (2a) or an alkyl ketene dimer wax (2b).

Furthermore, the present invention comprises a process for producing the multimodal composition as defined above.

A multimodal or at least bimodal, e.g. bimodal or trimodal, polymer may be produced by blending two or more monomodal polymers having differently centered maxima in their molecular weight distributions. The blending may be effected mechanically, e.g. analogously to the mechanical blending principle as known in the art. Alternatively, the multimodal or at least bimodal, e.g. bimodal or trimodal, polymer composition may be produced by polymerization using conditions which create a multimodal or at least bimodal, e.g. bimodal or trimodal, polymer composition, i.e. using a catalyst system for mixtures with two or more different catalytic sides, using two or more stage polymerization process with different process conditions in the different stages (i.e. different temperatures, pressures, polymerization media, hydrogen partial pressures, etc.). With the polymer as produced in such a sequential step process, i.e. by utilizing reactors coupled in series, and using different conditions in each reactor, the different polymer fractions produced in the different reactors will each have their own molecular weight distribution which may differ considerably from one another. The molecular weight distribution curve of the resulting final polymer can be regarded as superimposing of the molecular weight distribution curves of the polymer fractions which will accordingly show two or more distinct maxima, or at least the distinctively broadened maxima compared with the curves for individual fractions.

A polymer showing such a molecular weight distribution curve is called multimodal, trimodal or bimodal.

Multimodal polymers can be produced according to several processes, which are described, e.g. in WO 92/12182 and WO 97/22633.

A multimodal polymer is preferably produced in a multi-stage process in a multistage reaction sequence, such as described in WO 92/12182. The contents of this document are included herein by reference.

It is known to produce multimodal or at least bimodal, e.g. bimodal or trimodal, polymers, preferably multimodal or bimodal olefin-polymers, such as multimodal or bimodal polyethylenes in two or more reactors connected in series whereby the compounds (A) and (B) can be produced in any order.

According to the present invention, the main polymerization stages are preferably carried out as a combination of a slurry gas/gas-phase polymerization. The slurry polymerization is preferably performed in a so-called loop-reactor.

Optionally, and of more advantage, the main polymerization stages may be pre-ceded by a pre-polymerization in which case up to 20 wt %, preferably 1-10 wt %, more preferably 1-5 wt % of the total amount of polymer composition is produced. At the pre-polymerization point, all of the catalyst is preferably charged into a loop-reactor and a polymerization is performed as a slurry polymerization. Such a polymerization leads to less fine particles being produced in the following reactors and to a more homogeneous product being obtained in the end. Such a pre-polymerization is for instance described in WO 96/18662.

Generally, the technique results in a multimodal or at least bimodal, e.g. bimodal or trimodal, polymer composition thereby a Ziegler-Natta or metallocene catalyst in several successive polymerization reactors is used. For example in the production of a bimodal high-density polyethylene composition, a first ethylene polymer is produced in the first reactor under certain conditions with respect to the hydrogen-gas concentration, temperature, pressure and so forth. After the polymerization the reactor-polymer including the catalyst is separated from the reaction mixture and transferred to a second reactor where further polymerization takes place under other conditions.

The components (A) and (B) can be produced with any suitable catalyst system, preferably a coordination catalyst, such as a Ziegler-Natta catalyst system, preferably a coordination catalyst, such as a Ziegler-Natta catalyst of a transition metal of a group 3-10 of the periodic table (IUPAC), a metallocene, non-metallocene, in a manner known in the art. One example of a preferred Ziegler-Natta catalyst comprises Ti, Mg and Al, such as described in document EP 0 688 794 B1, which is included herewith by reference. It is a high-activity procatalyst comprising a particular inorganic support, a curing compound deposited on the support, wherein the curing compound is the same as or different from the titanium compound, whereby the inorganic support is contacted with an alkyl metal chloride which is soluble in a non-polar hydrocarbon solvent, and has the formula (RₙMeCl₃₋ₙ)ₘ, wherein R is a C₁ to C₂₀ alkyl group, Me is a metal of Group III (13) of the periodic table, n=1 or 2 and m=1 or 2, to give a first reaction product, and the first reaction product is contacted with a compound containing hydrocarbyl and hydrocarbyl oxide linked to magnesium which is soluble in non-polar hydrocarbon solvents, to give a second reaction product, and the second reaction product is contacted with a titanium compound which contains chlorine, having the formula ClₓTi (OR^{IV})₄₋ₓ, wherein R^{IV} is a C₂ to C₂₀ hydrocarbyl group and x=3 or 4, to give the procatalyst. Preferred supports are inorganic oxides, more preferably silicon dioxide or silica. Most preferably silica having an average particle size of 20 μm is used. Even more preferred tri-ethyl aluminium as a cocatalyst is used. Alternatively, a metallocene of group 4 metal can be used.

Preferably, polymer (A), the low molecular weight (LMW) polymer, is produced with addition or no addition of comonomer in a first reactor, and also the polyolefin (B), the high molecular weight (HMW) polymer, is produced with addition or no addition, more preferably with addition, of comonomer in the second reactor.

The resulting end product consists of an intimate mixture of polymers from the two reactors, the different molecular weight distribution occurs of these polymers together forming a molecular weight distribution curve having a broad maximum or two maxima, i.e. the end product is a multimodal or bimodal polymer mixture. Since multimodal and, in particular, bimodal polymers, preferably ethylene polymers and the production thereof belong to the prior art, no detailed description is called for here, but reference is made to the above-mentioned document WO 92/12182. It will be noted that the order of the reaction stages may be reversed.

Preferably, as stated above, the multimodal polymer composition according to the invention is a bimodal or trimodal polymer composition. It is also preferred that this bimodal or trimodal polymer composition has been produced by polymerization as described above under different polymerization conditions in two or more polymerization reactors connected in series.

Furthermore, it is preferred that for the multimodal composition according to this invention a process is used as defined above whereby
a) polymer (A) and polyolefin (B) are produced together in a multi-stage process comprising a loop reactor and a gas-phase reactor, wherein polymer (A) is generated in at least one loop reactor and the polyolefin (B) is generated in a gas-phase reactor in the presence of the reaction product (A) of the loop reactor, and
b) filler (C) and the composition comprising polymer (A) and polyolefin (B) are blended together and compounded.

In particular, a multi-stage process is used as described above. Especially, it is preferred that a loop reactor is operated at 75 to 100° C., more preferably in the range of 85 to 100° C. and most preferably in the range of 90 to 98° C. Thereby, the pressure is preferably 58 to 68 bar, more preferably 60 to 65 bar.

Preferably, polymer (A) is prepolymerized in a first loop reactor and then continuously removed to a second loop reactor where the polymer (A) is further polymerized. It is preferred that the temperature in the second loop reactor is 90 to 98° C., more preferably about 95° C. Thereby, the pressure is preferably 58 to 68 bar, more preferably about 60 bar.

In addition, it is preferred that in the second loop reactor, the ethylene concentration is 4 to 10 mol %, more preferably 5 to 8 mol % and most preferably about 6.7 mol %.

The hydrogen to ethylene mol-ratio highly depends on the catalyst used. It must be adjusted to render the desired melt flow rate MFR of the polymer withdrawn from the loop reactor. For the preferred catalyst as described it is preferred that the ratio of hydrogen to ethylene is 100 to 800 mol/kmol and more preferably 300 to 700 mol/kmol, still more preferably 400 to 650 mol/kmol and most preferred about 550 mol/kmol.

The polymer slurry is then preferably removed from the loop reactor by using settling lacks and is then preferably introduced into a flash vessel operating preferably at about 3 bar pressure, where the polymer is separated from most of the fluid phase. The polymer is then preferably transferred into a gas-phase reactor operating preferably at 75 to 95° C., more preferably 80 to 90° C. and most preferably about 85° C., and at preferably 10 to 50 bar, more preferably 15 to 25 bar and most preferably about 20 bar.

Additionally, ethylene comonomers were used and hydrogen as well as nitrogen as an inert gas are preferably introduced into the reactor so that the fractional ethylene in the fluidization gas is preferably 1 to 10 mol %, more preferably 1 to 5 mol % and most preferably about 2.5 mol % and the ratio of hydrogen to ethylene is preferably 100 to 400 mol/kmol, more preferably 150 to 300 mol/kmol and most preferably about 210 mol/kmol.

The comonomer to ethylene ratio has influence on the desired density of the bimodal polymer. Hence, it is preferred that the ratio of comonomer to ethylene is 20 to 150 mol/kmol, more preferably 50 to 100 mol/kmol and most preferably about 80 mol/kmol. Preferably, after the polymer is withdrawn from the gas-phase reactor and then mixed with further additives as anti-oxidants and/or process stabilizers by blending.

The polymer mix of polymer (A) and polyolefin (B) is then blended with filler (C) and with any suitable method known in the art. These methods include compounding in a twin-screw extruder, like a counter-rotating twin-screw extruder or a co-rotating twin-screw extruder and compounding in a single-screw extruder.

In addition, the present invention comprises a new multi-layer material comprising at least
a) a substrate as a first layer (I) and
b) a multimodal polymer composition as described above as at least one further layer (II).

Preferably, the multi-layer material consists of
a) a substrate as a first layer (I) and
b) a multimodal polymer composition as described above as at least one further layer (II).

It is further preferred that the multi-layer material is a two-layer or three-layer material consisting of a substrate as a first layer and of a polymer composition for the second and third layer, whereby preferably at least the second layer is a polymer composition as defined above. The layers can of course be in any order. Optionally, this multi-layer material comprises adhesion promoters as tetra-isopropyl titanate, tetra-stearyl titanate, tetrakis(2-ethylhexyl)titanate, poly(dibutyltitanate).

Preferably, the substrate is selected from the group consisting of paper, paperboard, aluminium film and plastic film.

Preferably, the multi-layer material comprises as a further layer (III) a low density polyethylene (LDPE). Thereby, it is preferred that the low density polyethylene has a density of 900 to 950 kg/m³, more preferably from 915 to 925 kg/m³. In addition, it is preferred that the melt flow rate MFR₂ of the low density polyethylene (LDPE) is of 2.0 to 20.0 g/10 min, more preferably from 3.0 to 10.0 g/10 mm.

Preferably, the coating weight of layer (II) comprising the polymer composition according to the present invention ranges from 5 to 60 g/m² and more preferably from 10 to 45 g/m². Additionally, it is preferred that the layer (III) comprising a low density polyethylene (LDPE) as described above has a coating weight of 0 to 25, more preferably from 3 to 18 g/m².

The present invention also comprises a film, preferably a cast film, comprising the multimodal polymer composition as described above, more preferably, the film, preferably the cast film, consists of the multimodal polymer composition of the present invention.

Furthermore, the present invention provides a process for producing a multi-layer material comprising the inventive polymer composition as described above. Thereby, it is preferred that the multimodal polymer composition as described above is applied on a substrate by a film-coating line comprising an unwind, a wind, a chill roll and a coating die. Preferably, the speed of the coating line ranges from 50 to 5000 nm/min, more preferably from 100 to 1500 nm/min. The coating may be done as any coating line known in the art. It is preferred to employ a coating line with at least two extruders to make it possible to produce multilayered coatings with different polymers. It is also possible to have arrangements to treat the polymer melt exiting the die to improve adhesion, e.g. by ozone treatment, corona treatment or flame treatment.

In addition, the present invention comprises the use of the multimodal polymer composition as defined above for extrusion coating, in particular for extrusion coating producing a multi-layer material as described above.

Furthermore, the present invention relates to the use of the multimodal polymer composition for films, preferably cast films.

In the following the present invention is demonstrated by means of examples.

### EXAMPLES

### Measurements

WVTR:

Water vapor transmission rate was measured at 90% relative humidity and 38° C. temperature according to the method ASTM E96.

Basis Weight or Coating Weight:

Basis weight (or coating weight) was determined as follows: Five samples were cut off from the extrusion coated paper parallel in the transverse direction of the line. The size of the samples was 10 cm×10 cm. The samples were dried in an oven at 105° C. for one hour. The samples were then weighed and the coating weight was calculated as the difference between the basis weight of the coated structure and the basis weight of the substrate. The result was given as a weight of the plastic per square meter.

Molecular Weight Averages and Molecular Weight Distribution:

Molecular weight averages and molecular weight distribution were determined by ISO 16014, part 2 universal calibration (narrow MWD polystyrene standards (universal alibration) and a set of 2× mixed bed+1×10⁷ Å Tosohas (JP) columns were used).

Density:

Density was determined according to ISO 1183-1987.

Melt Flow Rate or Melt Index:

Melt flow rate (also referred to as melt index) was determined according to ISO 1133, at 190° C. The load used in the measurement is indicated as a subscript, i.e. MFR₂ denotes the MFR measured under 2.16 kg load.

Flow Rate Ratio:

Flow rate ratio is a ratio of two melt flow rates measured for the same polymer under two different loads. The loads are indicated as a subscript, i.e., FRR_{5/2} denotes the ratio of MFR₅ to MFR₂.

Curling:

Curling was determined by cutting a circular sample having an area of 100 cm² within two hours after the coating. The sample is then allowed freely to curl at the table for two minutes. The curl is then measured as the difference (in mm) from the table to the curled sheet.

### Example 1

Into a 50 dm3 loop reactor, operated at 80° C. and 65 bar, was introduced 1 kg/h ethylene, 22 kg/h propane, 2 g/h hydrogen and a polymerization catalyst prepared according to Example 3 of EP-B-688794, except that as a support was used silica having an average particle size of 20 μm, together with triethylaluminium cocatalyst in such a quantity that the production rate of polyethylene was 6.8 kg/h. The molar ratio of the aluminium of the cocatalyst to the titanium of the solid catalyst component was 30. The melt index MFR₂ and the density of the polymer were estimated to be 30 g/10 min and 970 kg/m³, respectively.

The slurry was continuously removed from the loop reactor and introduced into a second loop reactor having a volume of 500 dm3 and operating at 95° C. temperature and 60 bar pressure. Additional ethylene, propane and hydrogen were added so that the ethylene concentration was 6.7% by mole and the ratio of hydrogen to ethylene was 550 mol/kmol. The polymer production rate was 27 kg/h and the MFR₂ and density of the polymer were 400 g/10 min and 974 kg/m³, respectively.

The polymer slurry was removed from the loop reactor by using settling legs and was then introduced into a flash vessel operating at 3 bar pressure, where the polymer was separated from most of the fluid phase. The polymer was then transferred into a gas phase reactor operating at 85° C. and 20 bar. Additional ethylene, 1-butene comonomer and hydrogen, as well as nitrogen as inert gas, were introduced into the reactor so that the fraction of ethylene in the fluidization gas was 2.5% by mole and the ratios of hydrogen to ethylene and 1-butene to ethylene were 210 and 80 mol/kmol, respectively. The copolymer production rate in the gas phase reactor was 25 kg/h.

The polymer withdrawn from the gas phase reactor was then mixed with 400 ppm Irganox B561 and pelletized by using a co-rotating twin screw extruder ZSK70 manufactured by Werner and Pfleiderer. The melt temperature was 199° C. during the extrusion. The polymer melt was extruded through a die plate into a water bath where it was instantaneously cut to pellets by a rotating knife. The polymer pellets were dried. The pelletized polymer had MFR₂ of 9.0 g/10 min and density 960 kg/m³.

### Example 2

A dry blend of pellets was made of 700 kg of the polymer prepared according to the Example 1, and of 300 kg of talc filler Finntalc MO5SL, manufactured and sold by Mondo Minerals. This dry blend was then compounded and pelletized by using the above mentioned ZSK70 extruder. The melt temperature during the extrusion was 200° C.

### Example 3

The polymer compositions prepared according to Example 2 was used in extrusion coating. The coating was done on a Beloit pilot extrusion coating line with two 4.5″ extruders having an L/D ratio (length to diameter) of 24 and output with LDPE of 450 kg/h and one 2.5″ extruder having an L/D ratio of 30 and output with LDPE of 170 kg/h. The die was a Peter Cloeren die with a five-layer feedblock. The temperature of the polymer melt at the die was 315° C.

The substrate was UG paper having a basis weight of 60 g/m². The speed of the coating line was 100 m/min. A co-extruded coating was produced with CA8200, which is an LDPE designed for extrusion coating, manufactured and sold by Borealis. It has MFR₂ of 7.5 g/10 min and density of 920 kg/m³. The coating weight of the LDPE layer was 5 g/m² and of the composition layer 15 g/m².

The WVTR of the coating was measured and it was found to be 7.2 g/m²/24 h.

### Example 4

The procedure of Example 3 was repeated with the exception that the coating weights of CA8200 and filled bimodal polymer were 15 g/m² and 15 g/m², respectively.

The WVTR was found to be 5.5 g/m²/24 h.

### Example 5

The procedure of Example 3 was repeated with the exception that the coating weights of CA8200 and filled bimodal polymer were 10 g/m² and 20 g/m², respectively.

The WVTR was found to be 5.0 g/m²/24 h.

### Example 6

The procedure of Example 3 was repeated with the exception that the coating was done as mono-layer coating without CA8200 and the coating weight of filled bimodal polymer was 40 g/m².

The WVTR was found to 2.9 g/m²/24 h.

### Comparative Example 1

The procedure of Example 5 was repeated with the exception that the polymer produced according to Example 1 was used in place of the composition produced according to Example 2.

The WVTR was found to be 8.3 g/m²/24 h.

### Comparative Example 2

The procedure of Example 6 was repeated with the exception that the polymer produced according to Example 1 was used in place of the composition produced according to Example 2 and that the coating weight was 20 g/m².

The WVTR was found to be 10.0 g/m²/24 h.

### Comparative Example 3

The procedure of Comparative Example 2 was repeated, except that a commercial LDPE designed for extrusion coating, CA7320 was used in place of the bimodal polymer.

The WVTR was found to be 17.8 g/m²/24 h.

### Comparative Example 4

The procedure of Comparative Example 3 was repeated, except that the coating weight was 30 g/m².

The WVTR was found to be 11.8 g/m²/24 h.

TABLE 1
Extrusion coating results for compositions containing bimodal HDPE and talc.

| | | Coating weight | Coating weight | WVTR | Curling |
|---|---|---|---|---|---|
| Example | Composition | composition g/m² | LDPE g/m² | g/m²/24 h | mm |
| Example 3 | In-situ/talc | 15 | 5 | 7.2 | 31 |
| Example 4 | In-situ/talc | 15 | 15 | 5.5 | 36 |
| Example 5 | In-situ/talc | 20 | 10 | 5.0 | 40 |
| Example 6 | In-situ/talc | 40 | 0 | 2.9 | 52 |
| Comparative | In-situ/— | 20 | 10 | 8.3 | high* |
| Example 1 | | | | | |
| Comparative | In-situ/— | 20 | 0 | 10.0 | high* |
| Example 2 | | | | | |
| Comparative | LDPE/— | 0 | 20 | 17.8 | 20 |
| Example 3 | | | | | |
| Comparative | LDPE/— | 0 | 30 | 11.8 | 32 |
| Example 4 | | | | | |

high* denotes that the sample curled so strongly that no meaningful numerical vale could be obtained.

### Example 7

The procedure of Example 2 was repeated, except that in place of the polymer produced according to Example 1, an LDPE polymer CA8200 was used. Then, 500 kg of thus obtained composition was dry blended with 500 kg of the polymer produced according to Example 1.

### Example 8

The polymer compositions prepared according to Example 7 was used in extrusion coating. The coating was done on a Beloit pilot extrusion coating line with two 4.5″ extruders having an L/D ratio (length to diameter) of 24 and output with LDPE of 450 kg/h and one 2.5″ extruder having an L/D ratio of 30 and output with LDPE of 170 kg/h. The die was a Peter Cloeren die with a five-layer feedblock. The temperature of the polymer melt at the die was 315° C.

The substrate was an aluminium foil. The speed of the coating line was 100 m/min. A co-extruded coating was produced with CA8200, which is an LDPE designed for extrusion coating, manufactured and sold by Borealis. It has MFR₂ of 7.5 g/10 min and density of 920 kg/m³. The polymer composition of Example 7 was extruded against the aluminium foil and CA8200 was extruded as the outer layer. The coating weight of the LDPE layer was 15 g/m² and of the layer containing the composition of Example 7 of 15 g/m².

The adhesion to the aluminium foil was good, so that the coating could not be peeled off by hand.

### Comparative Example 5

The procedure of Example 8 was followed, except that CA8200 was used in place of the composition of Example 7. Thus, only a mono-layer coating was produced.

The adhesion to the aluminium foil was so weak that the coating could easily be peeled off from the foil by hand.

### Example 9

A dry blend of pellets was made of 650 kg of the polymer prepared according to the Example 1, of 300 kg of talc filler Finntalc MO5SL, manufactured and sold by Mondo Minerals, and of 50 kg Licocene PP6100, supplier Clariant. This dry blend was then compounded and pelletized by using the above mentioned ZSK70 extruder. The melt temperature during the extrusion was 200° C. Licocene PP6100 is a low molecular weight propylene polymer having a number average molecular weight of 2090 g/mol, weight average molecular weight 5370 g/mol, z-average molecular weight 10900 g/mol and melting temperature in DSC analysis 109° C. The composition had a density of 1195.7 kg/m³ and MFR₂ of 6.1 g/10 min.

### Comparative Example 6

A dry blend of pellets was made of 700 kg of the polymer manufactured and marketed by Borealis under a trade name MG9621, a unimodal ethylene polymer having an MFR₂ of 12 g/10 min and a density of 962 kg/m³ and of 300 kg of talc filler Finntalc MO5SL, manufactured and sold by Mondo Minerals. This dry blend was then compounded and pelletised by using the above mentioned ZSK70 extruder. The melt temperature during the extrusion was 200° C. The composition had a density of 1187.4 kg/m³ and MFR₂ of 8.8 g/10 min.

### Example 10

The procedure of Example 9 was repeated, except that in place of the polymer according to Example 1 the polymer MG9621 was used. The composition had a density of 1195.9 kg/m³ and MFR₂ of 10.8 g/10 min.

### Example 11

The procedure of Example 10 was repeated, except that in place of Licocene PP6100, Raisares A62 was used. Raisares A62, supplied by Raisio Chemicals, is an alkyl ketene dimer having a number average molecular weight of 290 g/mol, weight average molecular weight 330 g/mol, z-average molecular weight 380 g/mol and melting temperature in DSC analysis 62° C. The composition had a density of 1191.3 kg/m³ and MFR₂ of 13.6 g/10 min.

TABLE 2
Data for compositions containing talc,
HDPE and wax used in extrusion coating.

| | | MFR₂ | Density |
|---|---|---|---|
| Example | Composition | g/10 min | kg/m³ |
| Example 9 | In-situ/PP/talc | 6.1 | 1195.7 |
| Comparative | HD/—/talc | 8.8 | 1187.4 |
| Example 6 | | | |
| Example 10 | HD/PP/talc | 10.8 | 1195.9 |
| Example 11 | HD/AKD/talc | 13.6 | 1191.3 |

### Example 12

The polymer composition prepared according to Example 9 was used in extrusion coating. The coating was done on a Beloit pilot extrusion coating line with two 4.5″ extruders having an L/D ratio (length to diameter) of 24 and output with LDPE of 450 kg/h and one 2.5″ extruder having an L/D ratio of 30 and output with LDPE of 170 kg/h. The die was a Peter Cloeren die with a five-layer feedblock. The temperature of the polymer melt at the die was 315° C.

The substrate was UG paper having a basis weight of 70 g/m². The speed of the coating line was 100 m/min. A coextruded coating was produced with CA8200, which is an LDPE designed for extrusion coating, manufactured and sold by Borealis. It has MFR₂ of 7.5 g/10 min and density of 920 kg/m³. The coating weight of the LDPE layer was 5 g/m² and of the composition layer 14 g/m².

The WVTR of the coating was measured and it was found to be 6.5 g/m²/24 h.

### Example 13

The procedure of Example 12 was repeated, except that the coating weight of the composition layer was 20 g/m².

The WVTR of the coating was measured and it was found to be 4.7 g/m²/24 h.

### Example 14

The procedure of Example 12 was repeated, except that the coating weight of the composition layer was 15 g/m² and that a composition prepared according to Example 2 was used.

The WVTR of the coating was measured and it was found to be 7.3 g/m²/24 h.

### Example 15

The procedure of Example 14 was repeated, except that the coating weight of the composition layer was 28 g/m².

The WVTR of the coating was measured and it was found to be 4.6 g/m²/24 h.

### Comparative Example 7

The procedure of Example 12 was repeated, except that the polymer composition according to Comparative Example 6 was used in place of the polymer composition according to Example 9 and that the coating weight of the composition layer was 13 g/m².

The WVTR of the coating was measured and it was found to be 8.8 g/m²/24 h.

### Example 16

The procedure of Example 14 was repeated, except that a composition according to Example 10 was used in place of the composition according to Example 2.

The WVTR of the coating was measured and it was found to be 7.9 g/m²/24 h.

### Example 17

The procedure of Example 16 was repeated except that the coating weight of the composition layer was 25 g/m².

The WVTR of the coating was measured and it was found to be 4.6 g/m²/24 h.

### Example 18

The procedure of Example 16 was repeated except that a composition according to Example 11 was used in place of the composition according to Example 10 and that the coating weight of the composition layer was 40 g/m².

Also, the coating was conducted at a lower temperature due to the low melting temperature of the AKD wax. Thus, the temperature of the melt at the die was 270° C. Even then the minimum total coating weight that could be obtained was 45 g/12, meaning 40 g/m² for the composition and 5 g/m² for LDPE. The coating contained some pinholes, which may explain the relatively high value of WVTR. The WVTR of the coating was measured and it was found to be 6.5 g/m²/24 h.

TABLE 3
Extrusion coating results for blends of HDPE, talc and wax.

| | | Coating weight of | WVTR |
|---|---|---|---|
| Example | Composition | composition g/m² | g/m²/24 h |
| Example 12 | In-situ/PP/talc | 14 | 6.5 |
| Example 13 | In-situ/PP/talc | 20 | 4.7 |
| Example 14 | In-situ/—/talc | 15 | 7.3 |
| Example 15 | In-situ/—/talc | 28 | 4.6 |
| Comparative | HD/—/talc | 13 | 8.8 |
| Example 7 | | | |
| Example 16 | HD/PP/talc | 15 | 7.9 |
| Example 17 | HD/PP/talc | 25 | 4.6 |
| Example 18 | HD/AKD/talc | 40* | 6.5 |

*Not possible to produce a thinner coating

### Example 19

The procedure of Example 9 was repeated. The composition was dried at 60° C. for six hours.

### Example 20

The procedure of Example 19 was repeated except that in place of Licocene PP6100 wax Raisares A62 was used.

### Comparative Example 8

The procedure of Example 9 was repeated, except that no talc was used and that the amount of Licocene PP6100 wax was 33 kg.

### Comparative Example 9

The procedure of Comparative Example 10 was repeated, except in place of Licocene PP6100 wax Raisares A62 was used.

### Example 21

The procedure of Example 19 was used except that the polymer having a trade name MG9621 was used in place of the polymer according to Example 1.

### Example 22

The procedure of Example 21 was repeated except that in place of Licocene PP6100 wax Raisares A62 was used.

TABLE 4
Data for compositions containing polyolefin
and talc used in cast films.

| | | MFR₂ | Density |
|---|---|---|---|
| Example | Composition | g/10 min | 920 kg/m³ |
| Example 19 | In-situ/PP/talc | 7.6 | 1176.3 |
| Example 20 | In-situ/AKD/talc | 9.6 | 1185.5 |
| Comparative | In-situ/PP/— | 8.6 | 959.1 |
| Example 8 | | | |
| Comparative | In-situ/AKD/— | 9.6 | 959.9 |
| Example 9 | | | |
| Example 21 | HD/PP/talc | 12.8 | 1195.9 |
| Example 22 | HD/AKD/talc | 13 | 1191.3 |

### Example 23

The composition of Example 19 was used to make a cast film on Collin laboratory scale cast film line, having a single screw extruder with a screw diameter of 30 mm and length to diameter (L/D) ratio of 30. The line speed was about 10 m/s (from 8.9 to 10.3 m/s), the output about 5 kg/h (from 4.91 to 6.07 kg/h), the die temperature 250° C. and the melt temperature 245° C. The temperature at the chill roll was about 70° C. (68 to 72° C.). The data can be found in Table 5.

### Example 24

The procedure of Example 23 was repeated, except that the composition of Example 20 was used in place of the composition of Example 19. Data can be found in Table 5.

### Comparative Example 10

The procedure of Example 23 was repeated, except that the composition of Comparative Example 9 was used in place of the composition of Example 19. Data can be found in Table 5.

### Comparative Example 11

The procedure of Example 23 was repeated, except that the composition of Comparative Example 10 was used in place of the composition of Example 19. Data can be found in Table 5.

### Example 25

The procedure of Example 23 was repeated, except that the composition of Example 21 was used in place of the composition of Example 19. Data can be found in Table 5.

### Example 26

The procedure of Example 23 was repeated, except that the composition of Example 22 was used in place of the composition of Example 19. Data can be found in Table 5.

TABLE 5
Cast film data.

| | | Thickness | WVTR |
|---|---|---|---|
| Example | Composition | μm | g/m²/24 h |
| Example 23 | In-situ/PP/talc | 43 | 3.4 |
| Example 24 | In-situ/AKD/talc | 45 | 3.2 |
| Comparative | In-situ/PP/— | 45 | 4.3 |
| Example 10 | | | |
| Comparative | In-situ/AKD/— | 47 | 4.8 |
| Example 11 | | | |
| Example 25 | HD/PP/talc | 46 | 2.8 |
| Example 26 | HD/AKD/talc | 43 | 2.9 |

1. A multimodal polymer composition comprising
a. at least one polymer (A) having a weight average molecular weight (M_{w}) of lower than 60000 g/mol;
b. at least one polyolefin (B) having a higher weight average molecular weight (M_{w}) than polymer (A); and
c. a filler (C), whereby
the polymer composition without filler (C) has a density of 940 kg/m³ or lower.

2. A polymer composition according to claim 1 characterized in that at least one polymer (A) is
(1) a polyolefin having a weight average molecular weight (M_{w}) of 10000 to 60000 g/mol, or
(2) a wax having weight average molecular weight (M_{w}) of less than 10000 g/mol.

3. A polymer composition according to claim 2 characterized in that the polyolefin (1) is a high density polyethylene (HDPE).

4. A polymer composition according to claim 2 characterized in that the wax (2) is selected from one or more of
(2a) a polypropylene wax having weight average molecular weight (M_{w}) of less than 10000 g/mol or a polypropylene wax having weight average molecular weight (Mw) of less than 10000 g/mol, or
(2b) an alkylketene dimer wax having weight average molecular weight (Mw) of less than 10000 g/mol.

5. A polymer composition according to claim 2 characterized in that the composition comprises a polyolefin (1) as polymer (A) and a wax (2) as a further polymer (A).

6. A polymer composition according to claim 1 characterized in that the polyolefin (B) has a weight average molecular weight (M_{w}) of higher than 80000 g/mol.

7. A polymer composition according to claim 1 characterized in that the polyolefin (B) is a polyethylene.

8. A polymer composition according to claim 7 characterized in that the polyolefin (B) is a high density polyethylene (HDPE).

9. A polymer composition according to claim 1 characterized in that the total polymer composition comprises 1 to 50 wt % of polymer (A), 40 to 90 wt % of polyolefin (B) and 1 to 50 wt % of filler (C).

10. A polymer composition according to claim 1 characterized in that the polymer composition without filler (C) has melt flow rate MFR₂, according to ISO 1133, at 190° C., of 5 to 20 g/10 min.

11. A polymer composition according to claim 1 characterized in that the polymer composition without filler (C) has melt flow rate MFR₅, according to ISO 1133, at 190° C., of 20 to 40 g/10 min.

12. A polymer composition according to claim 1 characterized in that the polymer composition without filler (C) has melt flow ratio MFR₅/MFR₂ of 2.5 to 4.5.

13. A polymer composition according to claim 1 characterized in that the polymer composition without filler (C) has a ratio of the weight average molecular weight (M_{w}) to the number average molecular weight (Mₙ) from 8 to 25.

14. A polymer composition according to claim 1 characterized in that 95 wt % of the filler (C) has a particle size of less than 10 μm.

15. A polymer composition according to claim 1 characterized in that the filler (C) is talc.

16. A polymer composition according to claim 1 characterized in that the polymer composition comprises additionally antioxidants(s) and/or process stabilizers of less than 2000 ppm in the total composition.

17. A polymer composition according to claim 1 characterized in that the polymer composition is a high density polyethylene (HDPE), whereby polymer (A) and polyolefin (B) are produced in a multi step polymerization process.

18. A polymer composition according to claim 17 characterized in that the amount of comonomer units in the high density polyethylene (HDPE) is 0.1 to 1.0 mol %.

19. A polymer composition according to claim 17 characterized in that the polymer (A) and the polyolefin (B) are a high density polyethylene (HDPB), whereby the comonomer units are selected from the group consisting of C₃ α-olefin, C₄ α-olefin, C₅ α-olefin, C₆ α-olefin, C₇ α-olefin, C₈ α-olefin, C₉ α-olefin, C₁₀ α-olefin, C₁₁ α-olefin, C₁₂ α-olefin, C₁₃ α-olefin, C₁₄ α-olefin, C₁₅ α-olefin, C₁₆ α-olefin, C₁₇α-olefin, C₁₈α-olefin, C₁₉α-olefin, and C₂₀α-olefin.

20. A polymer composition according to claim 1 characterized in that the polymer (A) is a wax (2) according to claim (4) and the polyolefin (B) is a high density polyethylene (HDPE).

21. A polymer composition according to claim 20 characterized in that the polymer composition comprises additionally a polyolefin (1) being a high density polyethylene (HDPE) as a further polymer (A).

22. A polymer composition according to claim 20 characterized in that the polymer composition is a high density polyethylene (HDPE) whereby polyolefin (1) (polymer (A)) being a high density polyethylene (HDPE) is the lower molecular weight fraction of HDPE and polyolefin (B) being a high density polyethylene (HDPE) is the higher molecular weight fraction of the HDPE.

23. A polymer composition according to claim 22 characterized in that the polymer (A) and polyolefin (B) are a mechanical blend, preferably an in-situ blend produced in a multistage polymerization process.

24. A multimodal polymer composition comprising
a. a polymer (A) being a polyethylene homopolymer having a weight average molecular weight (M_{w}) of lower than 60000 g/mol and a MFR₂ of 50 to 1000 g/10 min;
b. a polyolefin (B) being a polyethylene copolymer having a higher weight average molecular weight (M_{w}) than the polymer (A), a density of 940 to 970 kg/m³ and a MFR₂ of 1 to 25 g/10 min; and
c. 1 to 50 wt % of a filler (C), whereby
the polymer composition without filler (C) has a density of at least 940 kg/m³.

25. A polymer composition according to claim 24 characterized in that
the polymer (A) being a polyethylene homopolymer has a MFR₂ of 100 to 600 g/10 min; and
the polyolefin (B) being a polyethylene copolymer has a density of 945 to 968 kg/m³ and a MFR₂ of 5 to 20 g/10 min.

26. (canceled)

27. A polymer composition according to claim 26 characterized in that the wax (2) is present in the amount of 1 to 20 wt %.

28. A polymer composition according to claim 26 characterized in that the wax (2) is present in the amount of 1 to 10 wt %.

29. (canceled)

30. A multi-layer material comprising
a. a substrate as a first layer (I)
b. a multimodal polymer composition according to claim 1 as at least a further layer (II).

31. A multi-layer material according to claim 30 characterized in that the substrate is selected from the group consisting of paper, paperboard, aluminum film and plastic film.

32. A multi-layer material according to claim 30 characterized in that the multi-layer material comprises as a further layer (III) comprising a low density polyethylene (LDPB).

33. A multi-layer material according to claim 30 characterized in that the low density polyethylene (LDPE) layer (III) has a melt flow rate MFR₂, according to ISO 1133, at 190° C., of at least 5 g/10 mm.

34. (canceled)

35. A process for producing a composition according to claim 1 characterized in that
a. polymer (A) and polyolefin (B) are produced together in a multi-stage process comprising a loop reactor and a gas phase reactor, wherein polymer (A) is generated in at least one loop reactor and the polyolefin (B) is generated in a gas phase reactor; and
b. filler (C) and the composition comprising polymer (A) and polyolefin (B) are blended together and compounded.

36. A process for producing a composition according to claim 35 characterized in that the catalyst used for the process producing the composition comprising polymer (A) and polyolefin (B) is a high activity procatalyst comprising a particulate inorganic support, a chlorine compound deposited on the support, wherein the chlorine compound is the same as or different from the titanium compound, whereby
the inorganic support is contacted with an alkyl metal chloride which is soluble in non-polar hydrocarbon solvents, and has the formula RₙMECL₃ₙ)ₘ wherein R is a C₁-C₂₀ alkyl group, Me is a metal of group III (13) of the periodic table, n=1 or 2 and m=1 or 2, to give a first reaction product, and
the first reaction product is contacted with a compound containing hydrocarbyl and hydrocarbyl oxide linked to magnesium which is soluble in non-polar hydrocarbon solvents, to give a second reaction product, and the first reaction product is contacted with a compound containing hydrocarbyl and hydrocarbyl oxide linked to magnesium which is soluble in non-polar hydrocarbon solvents, to give a second reaction product, and the second reaction product is contacted with a titanium compound which contains chlorine, having the formula C1ₓTi(O^{IV})₄₋ₓ wherein R^{IV} is a C₂-C₂₀ hydrocarbyl group and x is 3 or 4, to give the procatalyst.

37. A process for producing a multi-layer material according to claim 30 characterized in that the multimodal polymer composition according to claim 1 is applied on the substrate by a film coating line comprising an unwind, a wind, a chill roll and a coating die.

38. (canceled)

39. (canceled)

40. (canceled)
